(19) United States
(12) Patent Application Publication
(10) Pub. No.: US 2007/0199956 A1
(43) Pub. Date: Aug. 30, 2007

(54) Poison dispenser and probe

(76) Inventor: Michael J. Cramer, Tacoma, WA (US)

Correspondence Address: Kevin Steinacker, 1201 Pacific Ave., Ste. 1401, Tacoma, WA, 98402, US

(21) Appl. No.: 11/709,556

(22) Filed: Feb. 21, 2007

Related U.S. Application Data
(60) Provisional application No. 60/776,484, filed on Feb. 24, 2006.

(51) Int. Cl. G01F 11/10

(52) U.S. Cl. 222/368

(57) ABSTRACT

The present invention provides a poison dispenser including a hollow shaft, a dispensing assembly attached to the shaft, and a poison supply removably attached to the dispensing assembly. A dispensing end of the shaft may be cut at an angle to create an oval dispensing opening. The dispensing assembly includes a hollow housing, a body rotatably located within the housing, a receptacle located within the body, and means to rotate the body in order to fill the receptacle with a portion of poison from the poison supply and deposit the poison through the shaft into a burrow.

### PRIORITY

The applicant claims priority from a Provisional Patent Application filed on Feb. 24, 2006 under Application No. 60/776,484.

### FEDERALLY SPONSORED RESEARCH

N/A

### FIELD OF THE INVENTION

The present invention generally relates to an apparatus for dispensing poison or bait into the runs or burrows of moles or similar animals. The invention may be adapted to dispense grain, feed, fertilizer, or seed for other uses.

### BACKGROUND OF THE INVENTION

Many devices are available to control and eliminate moles, gophers, and other pests. These devices generally include traps, probes, and poison dispensers. Normally, traps require holes to be dug in the ground in order to place the trap, whereas a poison dispenser can place poisoned food directly into the burrow with less disfiguration of the ground surface. After locating a burrow using a probe, some amount of poison is generally deposited into the burrow.

Each of the prior art devices for dispensing poison presents certain difficulties to the user. For example, the apparatus disclosed in U.S. Pat. No. 4,413,440 to Schultz is difficult to use in practice and the dispensing opening can become clogged with poison or dirt during use. U.S. Pat. No. 4,614,160 to Curlett discloses an apparatus with a complicated design that requires a two-step process to use. The apparatus disclosed in U.S. Pat. No. 6,502,720 to Schwederski requires the user to invert the device after every use in order to refill the dispensing chamber.

In order to maximize effectiveness, a poison dispenser should be able to deposit multiple measured doses of poison, bait, or other material without getting clogged with dirt or poison as the device is used to probe for burrows. It is further desirable that the device be easy to use, enabling the user to both dispense poison and refill the device with a minimum of effort. Yet another desirable characteristic is that the device be inexpensive to manufacture and maintain. Because the size of the required poison dose will vary depending on the pest and the type of poison, it is also desirable to have the ability to change the amount of poison dispensed at each use. The present invention fulfills these and other needs.

### SUMMARY OF THE INVENTION

The dispensing apparatus is constructed of a hollow shaft with a dispensing end and a top end, a dispensing assembly with a bottom end and a receiving end, and a poison supply. The bottom end of the dispensing assembly is securely attached to the top end of the shaft, and the poison supply is removably attached to the receiving end of the dispensing assembly. The dispensing end is cut at an angle to create a dispensing opening. The dispensing assembly includes a hollow cylindrical housing with a spherical enlarged portion, a ball located within the enlarged portion of the housing, a stem attached to the ball and extending out through the housing, and a handle attached to the stem. The ball has a receptacle, and may be rotated using the handle so that the receptacle is exposed either through the receiving end or the bottom end of the dispensing assembly.

The above summary of the present invention is not intended to represent each embodiment, or every aspect, of the present invention. The present invention also includes any additional features and benefits which are apparent from the detailed description and figures set forth below.

### BRIEF DESCRIPTION OF THE FIGURES

FIG. 1 is a view of the assembled device.

FIG. 2 is a side view of the dispensing assembly.

FIG. 3 is a cross-sectional view of the dispensing assembly taken along the line 3-3 in FIG. 2.

FIG. 4 is a top view of the ball-shaped body, showing the receptacle.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as described.

### DETAILED DESCRIPTION OF THE ILLUSTRATED EMBODIMENTS

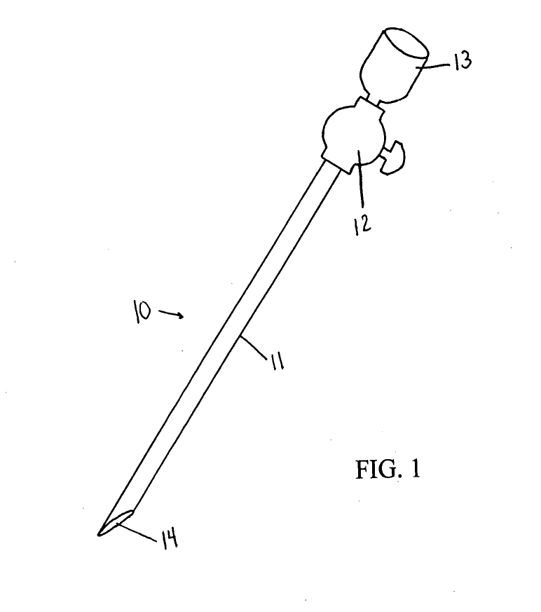

Referring to FIG. 1, a poison dispenser (10) is shown having a hollow shaft (11) with a dispensing end and a top end. The top end is securely attached to the bottom end of a dispensing assembly (12). A poison supply (13) is removably attached to a receiving end of the dispensing assembly (12). The dispensing end of the hollow shaft (11) is cut at an angle to form a dispensing opening (14).

In the preferred embodiment, the dispensing end of the shaft is cut at an angle, creating a point to facilitate probing the ground in order to locate or enter a burrow. When the angle of the cut is sufficiently small (less than 45°), a large oval dispensing opening is created. A large dispensing opening enables the user to see the poison as it is deposited and reduces the likelihood that the opening will become clogged with poison or dirt. A large dispensing opening also makes cleaning the opening easier in the event it does become clogged during use. In the preferred embodiment, therefore, the dispensing end of the shaft is cut at an angle of between 15° and 30°.

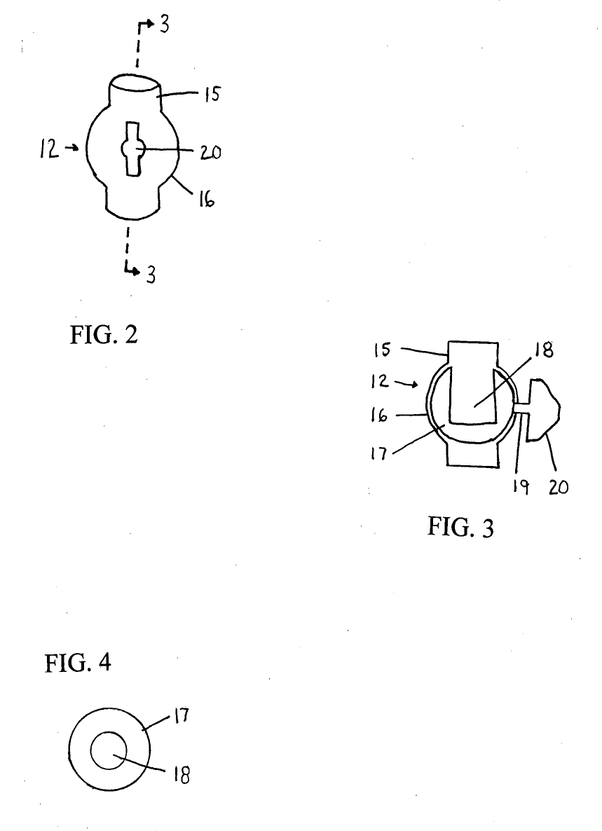

Referring to FIGS. 2-4, the dispensing assembly (12) is comprised of a hollow housing (15) which is generally cylindrical in shape, except for an enlarged portion (16), which is generally spherical. A body (17), or ball in the preferred embodiment, is positioned within the enlarged portion (16) of the housing (15). The body (17) is rotatable and sized so that it fits snugly within the enlarged portion (16). A receptacle (18) is located within the body or ball (17) and positioned so that it can be aligned with the cylindrical portion of the housing (15). A stem (19) is attached to the body or ball (17) and extends out through a hole in the housing (15). A handle (20) is attached to the stem (19), enabling the body or ball (17) to be rotated within the enlarged portion (16) of the housing (15) in order to expose the receptacle (18) alternately to the receiving end and the bottom end of the dispensing assembly (12).

The receptacle may be of any suitable shape, but takes the form of a cylinder in the preferred embodiment, with substantially the same diameter as the interior of the housing. The poison supply is formed so that it may be filled with the substance to be dispensed and may take a variety of shapes depending on the embodiment. In the preferred embodiment, the poison supply is a plastic bottle, and has a cap to close the poison supply when not in use.

To use the apparatus, poison, bait, or another material is placed within the poison supply and attached to the dispensing assembly. The user can either use the apparatus itself as a probe to find a burrow, or may use a separate probe. Once a burrow is located, the dispensing end of the shaft is thrust into the burrow. To dispense poison, the handle is rotated until the receptacle is exposed to the receiving end and is facing the poison supply. Poison then fills the receptacle under the force of gravity. The handle is then rotated 180° so that the receptacle is exposed to the bottom end and is facing the dispensing opening located within the burrow. A discrete amount of poison will then fall under the force of gravity through the hollow shaft and out of the dispensing opening into the burrow. The amount of poison deposited will be determined by the volume of the receptacle. Thus, one could reduce the amount deposited by partially filling the receptacle with an appropriately sized rubber cork or another suitable object. When storing the device, the poison supply can be removed and closed securely to prevent access to the poison by children, animals, or unauthorized individuals.

In the preferred embodiment, the shaft is constructed of pvc pipe, with the dispensing assembly also being pvc, although one skilled in the art will recognize that any suitable material may be used for construction, including other kinds of plastic or various metals. The shaft could be comprised of multiple sections of telescoping cylinders such that the length of the shaft may be adjusted and the entire shaft collapsed for storage. In another embodiment, the shaft is constructed of multiple sections which can be fitted together for use and disassembled for storage.

In other embodiments, the enlarged portion and body may be cylindrical rather than spherical, or may take other appropriate shapes. The enlarged portion and body should be shaped so that the body can be rotated to dispense the material in the receptacle. Further, the enlarged portion and body should be sized so that only the material in the receptacle passes from the receiving end to the bottom end of the dispensing assembly (in other words, the material to be dispensed should not fall around the body while the body is being rotated).

In another embodiment, the housing does not have an enlarged portion, but the body is sized to substantially restrict the passage of material through the dispensing assembly, except what is contained within the receptacle. In this embodiment, the body is held in position within the housing by the stem or other appropriate means.

In an alternate embodiment, a shaft handle, comprising a short straight section of pvc pipe or other suitable material, may be attached at right angles to the shaft. Alternatively, a second shaft may be attached between the dispensing assembly and the poison supply. The shaft handle could then be attached to the second shaft.

While the invention is susceptible to various modifications and alternative forms, specific embodiments thereof have been shown by way of example in the drawings and herein described in detail. One skilled in the art will recognize suitable substitutions. It should be understood, however, that it is not intended to limit the invention to the particular forms disclosed, but on the contrary, the intention is to cover all modifications, equivalents, and alternatives falling within the spirit and scope of the invention as described.

I claim:

1. A poison dispenser comprising:
a hollow shaft;
a dispensing assembly, a bottom end of which is attached to a top end of said shaft;
and a poison supply removably attached to a receiving end of said dispensing assembly.

2. The poison dispenser of claim 1 in which a dispensing end of said shaft opposite said top end is cut at an angle to form a dispensing opening.

3. The poison dispenser of claim 1 in which said shaft is comprised of two or more telescoping sections.

4. The poison dispenser of claim 1 in which said shaft is comprised of two or more sections removably fitted together.

5. The poison dispenser of claim 1 in which said dispensing assembly comprises:
a hollow housing, a body rotatably located within said housing between said bottom end and said receiving end, a receptacle located within said body, and means to rotate said body such that said receptacle may be exposed to said receiving end or said bottom end.

6. The poison dispenser of claim 1 in which said dispensing assembly comprises:
a hollow housing, a body rotatably located within said housing between said bottom end and said receiving end, a receptacle located within said body, a stem attached to said body and passing through a hole in said housing, and a handle attached to said stem, said stem and said hole being located such that said receptacle may be exposed to said receiving end or said bottom end by rotating said handle.

7. The poison dispenser of claim 1 in which said dispensing assembly comprises:
a hollow housing having an enlarged portion between said bottom end and said receiving end, a body rotatably located within said enlarged portion, a receptacle located within said body, and means to rotate said body such that said receptacle may be exposed to said receiving end or said bottom end.

8. The poison dispenser of claim 7 in which said enlarged portion and said body are generally spherical in shape.

9. The poison dispenser of claim 1, further comprising a shaft handle attached to said shaft.

10. A poison dispenser, comprising:
a hollow shaft having a dispensing end and a top end, the dispensing end being cut at an angle to form a dispensing opening;
a dispensing assembly, a bottom end of which is attached to the top end of said shaft;
and a poison supply removably attached to a receiving end of said dispensing assembly.

11. The poison dispenser of claim 10, in which said dispensing assembly comprises:
a hollow housing, a body rotatably located within said housing between said bottom end and said receiving end, a receptacle located within said body, and means to rotate said body such that said receptacle may be exposed to said receiving end or said bottom end.

12. The poison dispenser of claim 10, in which said dispensing assembly comprises:
a hollow housing, a body rotatably located within said housing between said bottom end and said receiving end, a receptacle located within said body, a stem attached to said body and passing through a hole in said enlarged portion, and a handle attached to said stem, said stem and said hole being located such that said receptacle may be exposed to said receiving end or said bottom end by rotating said handle.

13. The poison dispenser of claim 10, in which said dispensing assembly comprises:
a hollow housing having a enlarged portion between said bottom end and said receiving end, a body rotatably located within said enlarged portion, a receptacle located within said body, and means to rotate said body such that said receptacle may be exposed to said receiving end or said bottom end.

14. The poison dispenser of claim 13 in which said enlarged portion and said body are generally spherical in shape.

15. The poison dispenser of claim 10, in which said angle is less than 45 degrees.

16. The poison dispenser of claim 10, in which said angle is between 15 and 30 degrees.

17. The poison dispenser of claim 12, in which said angle is less than 45 degrees.

18. The poison dispenser of claim 14, in which said angle is less than 45 degrees.

19. The poison dispenser of claim 18, in which said shaft is comprised of two or more telescoping sections.

20. The poison dispenser of claim 18, in which said shaft is comprised of two or more sections removably fitted together.
